(19) United States
(12) Patent Application Publication
(10) Pub. No.: US 2024/0304825 A1
(43) Pub. Date: Sep. 12, 2024

(54) METAL-AIR CELL AND METHOD OF MANUFACTURING

(71) Applicant: VARTA Microbattery GmbH, Ellwangen Jagst (DE)

(72) Inventor: Ulrich Kohls, Hüttlingen (DE)

(21) Appl. No.: 18/267,013

(22) PCT Filed: Feb. 11, 2022
(86) PCT No.: PCT/EP2022/053445

§ 371 Date: Jun. 13, 2023

(30) Foreign Application Priority Data
Feb. 16, 2021 (EP) 21157331.6

(51) Int. Cl. H01M 4/86; H01M 4/88; H01M 12/06

(52) U.S. Cl. CPC H01M 4/8668; H01M 4/8626; H01M 4/8825; H01M 12/06

(57) ABSTRACT

A metal-air cell has a first housing part and a second housing part that together form a cell housing. The metal-air cell includes a metal based anode and a layer-shaped air cathode and an electrolyte. The first housing part has at least one air passage opening. A layer-shaped air diffusor is disposed between the first housing part and the air cathode. A layer-shaped separator is arranged between the air cathode and the metal based anode. The layer-shaped air diffuser is air-permeable and has a first side facing the air cathode and a second side facing away from the air cathode, wherein the layer-shaped air diffuser has a hydrophobic coating on at least one of the sides.

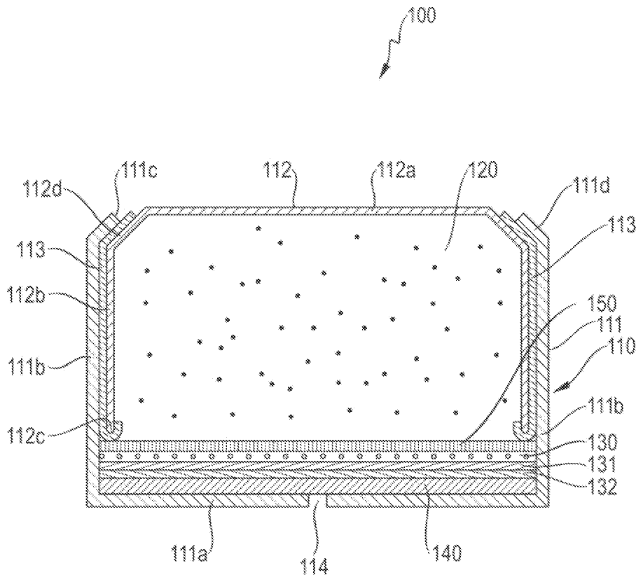

### TECHNICAL FIELD

This disclosure relates to a metal-air cell, a method of manufacturing a layer-shaped air diffusor, and the use of a layer-shaped air diffusor for manufacturing a metal-air cell.

### BACKGROUND

Metal-air cells usually contain a metal-based anode and an air cathode as electrochemical active components, which are spatially separated from each other by a separator, but at the same time connected via an ion-conductive electrolyte. The separator is usually impregnated with the electrolyte. During discharge, oxygen is reduced at the air cathode, accompanied by a take-up of electrons. Hydroxide ions are formed, which migrate via the electrolyte to the anode. There, the metal on which the anode is based is oxidized accompanied by a release of electrons. The resulting metal ions react with the hydroxide ions.

Both primary and secondary metal-air cells exist. A primary metal-air cell is not rechargeable. A secondary metal-air cell is recharged by applying a voltage between the anode and the air cathode and reversing the electrochemical reaction described. Oxygen is released in the process.

The best-known example of a metal-air cell is the zinc-air cell. In button cell form, it is used in particular as an energy storage cell for hearing aids.

Metal-air cells have a very high energy density because the demand for oxygen at the air cathode can be met by atmospheric oxygen from the surrounding environment. Accordingly, atmospheric oxygen must be supplied to the air cathode during the discharge process. Conversely, during the charging process of a secondary metal-air cell, oxygen generated at the air cathode must be removed. For these reasons, metal-air cells generally have housings that are provided with corresponding inlet and outlet openings. Generally, holes are made in the housing, for example, punched in as inlet and outlet openings.

Usually, gas diffusion electrodes are used as air cathodes in metal-air cells. Gas diffusion electrodes are electrodes in which the substances involved in the electrochemical reaction (generally a catalyst, an electrolyte and atmospheric oxygen) are present side by side in solid, liquid and gaseous form and can come into contact with each other. The catalyst catalyzes the reduction of atmospheric oxygen during discharge and, if necessary, also the oxidation of hydroxide ions during charging of the cells.

Plastic-bonded gas diffusion electrodes are frequently used as air cathodes, in particular in metal-air cells in button cell form. Such gas diffusion electrodes are described, for example, in DE 3722019 A1. In such electrodes, a plastic binder (e.g., polytetrafluoroethylene, PTFE for short) forms a porous matrix in which particles of an electrocatalytically active material (for example, of a noble metal such as platinum or palladium or a manganese oxide) are embedded. The electrocatalytically active material catalyzes the aforementioned conversion of atmospheric oxygen. Such electrodes are generally produced by rolling out a dry mixture of the binder and the catalyst to form a foil. The dry mixture can, for example, be rolled into a mesh or into an expanded metal grid of silver, nickel or silver-plated nickel. The metal mesh or expanded metal forms a conductor structure within the electrode and serves as a conductor.

If oxygen is reduced in such an air cathode, the electrons released in the process can be discharged via the aforementioned conductor structure. The conductor structure is preferably in direct contact with a part of the housing that serves as the cell's pole.

The aforementioned inlet(s) or outlet(s) for oxygen are generally made in the bottom of the housing of a metal-air cell, especially if it is a button cell. To allow the oxygen entering through the opening(s) to come into contact with the air cathode as directly as possible, the air cathode in such cells is usually positioned flat on the housing bottom so that it covers the opening(s). It is often provided that a layer-shaped air diffusor is provided between the air cathode and the housing bottom, for example, a porous filter paper.

GB 2109622 B describes a zinc-air cell in button cell form. A PTFE membrane is provided below the air cathode, which together with the air cathode forms a laminate. A porous air diffusion disk made of filter paper is provided between this laminate and the housing bottom with the air passage opening so that the entering air is distributed over the surface and a distributed access of the air to the cathode is achieved.

A similar structure of a zinc-air cell is known from WO 01/93366 A1. There, the air cathode is formed as a laminate with a PTFE membrane. An air distribution layer is provided between the gas-permeable PTFE membrane of the laminate and the housing bottom with the air inlet opening.

It is often a problem with metal-air cells that, especially during discharges under high-humidity conditions, the cells can leak through the air passage openings during or after the discharge. The reason for this is that the hygroscopic electrolyte absorbs the gaseous water from the ambient air. The higher the humidity, the more water the electrolyte absorbs. Due to this water absorption, the internal pressure in the metal-air cell increases to a point where the hydrophobic PTFE membrane of the air cathode laminate can no longer sufficiently repel the aqueous electrolyte. This results in the electrolyte being forced through the membrane. As soon as the electrolyte has penetrated the PTFE membrane in the direction of the air passage opening at the bottom of the housing, the porous air distribution layer, for example, an air distribution paper, is soaked up with the electrolyte and the cells leak out through the air passage openings.

WO 2006/098718 A1 describes a metal-air cell in which a further PTFE membrane is provided between an air cathode laminate with a hydrophobic membrane and an air distribution layer made of porous material, for example, paper.

WO 2008/051508 A2 deals with a metal-air cell in which an air cathode with a laminated PTFE membrane is provided. An air distribution layer is provided between the housing bottom and the air cathode laminate, which may be formed of porous paper or fibers. In alternative examples, the air distribution layer may be an air-permeable, hydrophobic PTFE membrane.

Such approaches do not address the problem of possible leakage of the metal-air cells in a satisfactory manner. It could therefore be helpful to provide a metal-air cell in which, on the one hand, leakage of the electrolyte is reliably prevented and, on the other hand, the desired functionality of the metal-air cell is ensured. Furthermore, it could be helpful to have a cost-effective solution provided which is also suitable, for example, for mass production of metal-air cells in an economical manner.

### SUMMARY

I provide a metal-air cell including a. a first housing part and a second housing part that together form a cell housing; and b. a metal based anode, a layer-shaped air cathode and an electrolyte, wherein c. the first housing part has at least one air passage opening; d. a layer-shaped air diffusor is arranged between the first housing part and the air cathode; e. a layer-shaped separator is arranged between the air cathode and the metal-based anode; f. the layer-shaped air diffusor is configured to be air permeable and has a first side facing the air cathode and a second side facing away from the air cathode; and g. the layer-shaped air diffusor has a hydrophobic coating on at least one of the sides.

I also provide a method of manufacturing a layer-shaped air diffusor for the metal-air cell including a. a first housing part and a second housing part that together form a cell housing; and b. a metal based anode, a layer-shaped air cathode and an electrolyte, wherein c. the first housing part has at least one air passage opening; d. a layer-shaped air diffusor is arranged between the first housing part and the air cathode; e. a layer-shaped separator is arranged between the air cathode and the metal-based anode; f. the layer-shaped air diffusor is configured to be air permeable and has a first side facing the air cathode and a second side facing away from the air cathode; and g. the layer-shaped air diffusor has a hydrophobic coating on at least one of the sides, including providing an air-permeable matrix; and providing the air-permeable matrix with a hydrophobic coating, wherein a dispersion of polytetrafluoroethylene, in an aqueous dispersant, or a solution or dispersion of at least one alkyl ketene dimer is used for the hydrophobic coating.

### BRIEF DESCRIPTION OF THE DRAWING

The drawing is a schematic sectional view through an example of a metal-air cell.

### DETAILED DESCRIPTION

A metal-air cell is characterized by a. to e.:
a. the metal-air cell has a first housing part and a second housing part that together form a cell housing;
b. the metal-air cell comprises a metal-based anode and a layer-shaped air cathode and an electrolyte;
c. the first housing part has at least one air passage opening;
d. a layer-shaped air diffusor is disposed between the first housing part and the air cathode; and
e. a layer-shaped separator is arranged between the air cathode and the metal based anode.

The cell is especially characterized by f. and g.:
f. the layer-shaped air diffusor is configured to be air permeable and has a first side facing the air cathode and a second side facing away from the air cathode; and
g. the layer-shaped air diffusor has a hydrophobic coating on at least one of the sides.

The layer-shaped air diffusor, which on the one hand is air-permeable and thus enables excellent distribution of the incoming air over the surface of the metal-air cell, and on the other hand has a hydrophobic coating that prevents the electrolyte from passing through, makes it possible to provide a metal-air cell in which leakage of the cell is reliably prevented or at least can be delayed for a long time even under extreme conditions. The hydrophobic coating is designed such that sufficient air permeability is ensured so that the cell can be supplied with sufficient atmospheric oxygen and desired functionality is maintained. The hydrophobic coating reliably prevents the air diffuser from becoming saturated with electrolyte in the sense of a wicking effect and drawing the electrolyte towards the air passage opening(s). The hydrophobic coating of the air diffuser keeps the electrolyte away from the air passage openings of the housing and the cell does not leak at all or, under extreme conditions, only at a very late stage via the air passage openings compared with conventional metal-air cells. Thus, when the metal-air cells are used in hearing aids, for example, it can be avoided that the devices are damaged by leaking electrolyte.

Besides the coated air diffuser, the metal-air cell can in principle be constructed like a conventional metal-air cell. In particular, the metal-air cell can have a conventional metal-containing anode, a conventional air cathode and a conventional separator arranged between the anode and the air cathode. For example, the gas diffusion electrodes described at the beginning are suitable as air cathodes for the metal-air cell. Suitable electrolytes for the metal-air cell are, for example, conventional aqueous electrolyte solutions, in particular alkaline aqueous solutions. Suitable separators include, for example, a nonwoven fabric impregnated with electrolyte or a porous plastic film impregnated with electrolyte.

As in conventional metal-air cells, the at least one air passage opening provided in the housing of the metal-air cell ensures that the air oxygen can penetrate the cell housing of the metal-air cell. Depending on the size and dimension of the air passage opening, one opening may be sufficient as an air passage opening. However, several air passage openings may also be provided, for example, 2 to 10 openings or, particularly preferably, 2 to 5 openings.

Compared to conventional metal-air cells having either an air diffuser layer in the form of a porous filter paper or similar, or a PTFE membrane as a purely hydrophobic material, the hydrophobic coating of the air diffuser ensures that desired distribution of the incoming air over the surface of the metal-air cell is achieved while reliably preventing leakage of the electrolyte.

The coated air diffuser does not necessarily have to be directly connected to the housing and/or the air cathode. However, it may also be provided that the layer-shaped air diffusor is fixed within the housing of the cell. For example, the layer-shaped air diffusor may be fixed to the cup bottom of the housing, for example, by one or more dots of an adhesive. Preferably, the layer-shaped air diffuser is connected to the cup bottom with an adhesive dot approximately in the center.

Particularly preferably, the hydrophobic coating is a polytetrafluoroethylene (PTFE) coating. Particularly suitable are unbranched, linearly built, semi-crystalline PTFE variants of fluorine and carbon. PTFE is hydrophobic and thus water repellent. In addition, it is extremely resistant to various chemicals, making it highly suitable for use in energy storage cells.

Particularly preferably, the metal-air cell is characterized by at least one of a. and b:
a. the hydrophobic coating is based on a coating with a dispersion of polytetrafluoroethylene, especially a water-based dispersion; and
b. the hydrophobic coating is based on a coating with a dispersion of polytetrafluoroethylene, in particular a dispersion in an aqueous dispersant, in particular in water, wherein the solid content of polytetrafluoroethylene in the dispersion is 5 to 75% by weight, preferably 15 to 60% by weight, particularly preferably 30±2% by weight.

The hydrophobic coating is preferably a particulate coating. In a particularly preferred manner, the coating comprises PTFE particles with an average size (d50) of 0.04-1 μm. A particularly preferred size range for the d50 value is 0.10-0.30 μm. In particular, the proportion of PTFE particles in the dispersion with a size <0.04 μm is less than 10%. Furthermore, it is preferred that the proportion of PTFE particles in the dispersion with a size >1 μm is less than 10%.

Corresponding dispersions of polytetrafluoroethylene, especially in water, can be easily prepared and processed. In principle, other dispersants are also possible. However, water is particularly preferred as a dispersant because it is available at low cost and can generally be used without further safety precautions. For example, a starting dispersion with a 60% solids content of PTFE can be used as a starting point to prepare a suitable dispersion. This starting dispersion can be mixed with water and used for coating.

The higher the percentage by weight of polytetrafluoroethylene in the dispersion, the more hydrophobic the coating and the more effectively leakage of the electrolyte can be prevented. However, it is particularly preferred that the proportion by weight of polytetrafluoroethylene in the dispersion is not more than 75 wt. % since a coating with a higher-percentage dispersion can significantly reduce the air permeability of the air diffuser and thus the air distribution properties of the air diffuser may no longer be desired. Particularly preferably, the percentage by weight of polytetrafluoroethylene is 5 to 75% by weight. A range of 15 to 60 wt. % is quite particularly preferred. Particularly preferably, the concentration or weight fraction of polytetrafluoroethylene in the dispersant is 30±2 wt %. These percentages refer to the solid content of polytetrafluoroethylene in the dispersion used for the coating.

In principle, other materials can also be used for the hydrophobic coating. For example, polyether ketones (PEK) or hydrophobic polyether sulfones are suitable as hydrophobic coating materials. Polyetheretherketone (PEEK), for example, is particularly suitable.

Particularly preferably, the hydrophobic coating is an alkyl ketene dimer coating.

Alkyl ketene dimers are generally based on the four-membered ring system of 2-oxetanone according to general structural formula:

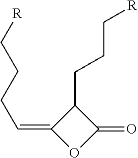

The residues R are each hydrocarbon groups, which may be identical or different. Preferably, they are unbranched or branched alkyl or alkenyl groups having 6 to 24 carbon atoms. Furthermore, the residues R may be cycloalkyl groups having at least 6 carbon atoms, or aryl groups having at least 6 carbon atoms, or aralkyl groups having at least 7 carbon atoms, or alkaryl groups having at least 7 carbon atoms, or mixtures thereof. Suitable alkyl ketene dimers are available, for example, under the trade name AQUAPEL® (e.g., company Solenis LLC, USA). AQUAPEL® 201, for example, is particularly suitable for the purposes of this disclosure.

A coating with at least one alkyl ketene dimer provides very good water repellency through the coating. At the same time, a particular advantage of the alkyl ketene dimer coating is that the coating generally has no or hardly any negative effect on the air permeability of the layer-shaped air diffusor, especially if the solids content in the dispersion is in the preferred ranges mentioned further below. In this respect, a coating with alkyl ketene dimers may be superior to a coating with polytetrafluoroethylene. A further advantage of a coating with alkyl ketene dimers over a coating with polytetrafluoroethylene is that alkyl ketene dimers are easier to handle and furthermore more environmentally friendly since no fluorine is contained.

Particularly preferably, the hydrophobic coating is based on a coating with a dispersion of at least one alkyl ketene dimer, in particular it is an aqueous dispersion. Alkyl ketene dimers are generally insoluble in water and are preferably provided for the coating as an aqueous dispersion. Since alkyl ketene dimers typically have a melting point in a range of about 45° C., mixtures of alkyl ketene dimers in water above about 50° C. are present as emulsions, i.e., as a two-phase system with liquid droplets in a liquid medium, and below about 40° C. are present as dispersions, i.e., as a two-phase system with solid particles in a liquid medium. Such dispersions with a temperature of <40° C. for coating are particularly preferred.

It is preferred if the solids content of the at least one alkyl ketene dimer in the dispersant is 0.01 to 8.0% by weight. Particularly preferably, the solids content is 0.05 to 5.0% by weight, especially preferably 0.08 to 3.0% by weight. A solids content of 0.7 to 0.9 wt. % in the coating dispersion is particularly preferred since surprisingly a very high hydrophobicity is already achieved at such low values and at the same time the air permeability is not impaired and the weight per unit area is not elevated. With such a solids content, I was able to achieve particularly good results, wherein very good water-blocking properties were combined with very good air permeability of the coated air diffuser. Good results were also obtained with a solids content of 0.16% by weight.

Preferably, the particle size of the alkyl ketene dimer in the dispersion for the coating is on average less than 1 μm, preferably less than 0.5 μm, for example, on average about 0.3 μm.

The pH of the coating dispersion is preferably below pH 7, particularly preferably less than pH 4. The coating dispersion may further contain stabilizing agents such as cationic starch or other substances. An example of a stabilizing agent is a water-soluble alkyl glycidyl ether-modified poly(aminoamide), as described in particular in EP 2691572 B1. Furthermore, the coating dispersion may contain other additives such as biocides or the like.

Particularly preferably, the metal-air cell is characterized by additional feature a:
a. the layer-shaped air diffuser comprises an air-permeable matrix formed of a hydrophilic material.

Particularly preferably, the metal-air cell has at least one of a. to d. with respect to the air-permeable matrix:
a. the air-permeable matrix is a nonwoven fabric;
b. the air-permeable matrix is formed of a fiber mixture, wherein preferably the fiber mixture comprises fibers of polyvinyl alcohol, in particular in a proportion of at least 50% by weight;
c. the air-permeable matrix has a weight per unit area in the uncoated state of 20 to 30 g/m², preferably 24 to 26 g/m²; and
d. the air-permeable matrix has, in the uncoated state, an air permeability of 20,000 to 40,000 cm³/cm²*min, preferably 25,000 to 35,000 cm³/cm²*min, particularly preferably 29,000 to 30,000 cm³/cm²*min.

Particularly preferably, the immediately preceding a. and b., or a. and b. and c., or a. and b. and c. and d. are each realized in combination with one another.

The porosity of a particularly suitable nonwoven (before coating) is, for example, 70 to 90%, preferably about 80%.

The fiber blend can, for example, be a mixture of polyvinyl alcohol fibers and rayon fibers. The proportion of polyvinyl alcohol fibers can, for example, be 50-80%, preferably 60-70%. The proportion of rayon fibers may, for example, be 20-50%, preferably 30-40%. Particularly preferably, the fiber blend consists of 65% polyvinyl alcohol fibers and 35% rayon fibers.

In principle, all fibers that can be processed easily in terms of production technology and that are resistant to the alkaline electrolyte of the metal-air cell, for example, and that have no negative influence on the cell chemistry are suitable for the production of the fiber mixture.

The average length of the individual fibers can be 1 mm to 10 mm, for example, and 3 to 5 mm. For example, 4 mm, is particularly preferred.

In general, a nonwoven is characterized by being formed by fibers of limited length, which in principle are connected in any way, but which are not structured by weaving or knitting or the like. A paper is therefore also to be understood as fibrous web.

It is particularly preferred that the air-permeable matrix is formed of a fiber blend that is more hydrophilic than a nonwoven made of PTFE. For this purpose, it preferably comprises fibers of a polymer that is more hydrophilic than PTFE, for example, polyvinyl alcohol or a polyvinyl alcohol derivative. It preferably comprises these fibers in a proportion of at least 50%. The required hydrophobic properties are imparted to the nonwoven by coating it with the PTFE dispersion or with the alkyl ketene dimer coating.

A nonwoven is particularly preferred if it contains substantial proportions of fibers of polyvinyl alcohol. A nonwoven fabric that can be produced in this way is particularly suitable for the production of a layer-shaped air diffuser since particularly good results can be achieved with respect to stability, air permeability and coating with the PTFE dispersion or with alkyl ketene dimers with regard to preventing leakage of the resulting cells and with regard to desired air distribution within the cells.

A weight per unit area of the air-permeable matrix in the uncoated state of 25 g/m² is particularly suitable since with such a thickness of the material for the air-permeable matrix of the air diffuser very good results have been obtained with regard to the properties of the resulting metal-air cell. The same applies to the air permeability of the matrix in the uncoated state, which 29,000 to 30,000 cm/cm³²*min led to particularly good results for the metal-air cell produced with it.

Particularly preferably, the layer-shaped air diffusor has a coating on both sides. In a particularly simple and practicable manner such a coating of the air diffuser can be achieved by an immersion process in which the air-permeable matrix of the air diffuser is immersed in a corresponding dispersion with PTFE or with alkyl ketene dimers. Subsequently, drying, for example, at room temperature, can be provided. This process can be automated very well so that it is also suitable for mass production in the manufacture of the metal-air cells. Advantageously, larger sections of the sheet-like material of the air-permeable matrix are coated in an immersion process. The required mold for the air diffuser can then be produced, for example, by a stamping process.

In principle, it is also possible for the layer-shaped air diffuser to be provided with the hydrophobic coating on only one side. In these examples, it is advantageous if the side with the hydrophobic coating is located in the direction of the air cathode. In this example, leakage of the electrolyte is prevented in a particularly reliable manner since the side of the layer-shaped air diffuser with the hydrophobic coating is the side that primarily comes into contact with the electrolyte.

Particularly preferably, in the metal-air cell, the cell has, with respect to the layer-shaped air diffusor, always a. or b.:
a. the layer-shaped air diffuser has a coating of polytetrafluoroethylene and a weight per unit area of 40 to 160 g/m², preferably 45 to 100 g/m², more preferably 60 to 70 g/m²; or
b. the layer-shaped air diffusor has a coating with at least one alkyl ketene dimer and a weight per unit area of 10 to 50 g/m², preferably 20 to 30 g/m².

Particularly good results have been obtained with a PTFE-coated air diffuser with a weight per unit area of 65±2 g/m² for the coated air diffuser with regard to the properties of the metal-air cell equipped with it. In this region of the weight per unit area of the coated material, where the uncoated air-permeable matrix has an air permeability of 29,000 cm/cm³²*min, the hydrophobic coating, which is preferably prepared with a 30 wt % dispersion of PTFE in water, does not adversely affect the air permeability. That is, the air permeability is very high despite the hydrophobic coating. In a particularly preferred manner, the air permeability of the PTFE-coated air diffuser is 21,000-23,000 cm³/cm²*min. On the other hand, the hydrophobic coating means that there is no leakage of the metal-air cell through the layer-shaped air diffusor. If the weight per unit area of the layer-shaped air diffusor is significantly higher, which can be achieved by coating with a higher-percentage PTFE dispersion, the air permeability of the air diffusor may be adversely affected so that the full functionality of the metal-air cell equipped with it can no longer be guaranteed.

In an air diffuser coated with alkyl ketene dimers, the preferred weight per unit area is 20 to 30 g/m², wherein an aqueous dispersion of alkyl ketene dimers containing, for example, 0.8 or 7.6% by weight is preferably used for the coating. The resulting hydrophobicity is very high, wherein at the same time no negative influence on the air permeability is detectable. In a particularly preferred manner, the air permeability of the air diffuser coated with alkyl ketene dimers is 21,000-23,000 cm³/cm²*min.

Further preferable examples of the metal-air cell are, at least one of a. and/or b.:
a. the metal-air cell comprises at least one additional layer between the air cathode and the layer-shaped air diffusor; and/or
b. the at least one additional layer is a hydrophobic membrane, preferably a membrane made of polytetrafluoroethylene.

Particularly preferably, the immediately aforementioned a. and b. are realized in combination with each other.

The additional layer between the air cathode and the layer-shaped air diffusor can be, for example, a PTFE membrane that forms an assembly, for example, a laminate, with the layer-shaped air cathode, for example, by lamination or another joining process. In other examples, the PTFE membrane can lie loosely between the air cathode and the air diffuser.

In addition, further preferably, a further layer, in particular a further PTFE membrane, can be provided between the air cathode assembly (laminate) and the air diffuser. In this way, for example, a pore gradient can be realized that improves the air supply to the air cathode. At the same time, a particularly high degree of leakage safety of the metal-air cell can be realized, which can be particularly advantageous under extreme high-humidity conditions. The further PTFE membrane can, for example, lie loosely between the air cathode or an air cathode laminate and the layer-shaped air diffusor. In other examples, the further layer, i.e., in particular the further PTFE membrane, can also be firmly connected (for example, by lamination or other joining processes) to the air cathode assembly so that the air cathode is equipped with two PTFE membranes.

Comparable to air cathodes in conventional metal-air cells, the air cathode of the metal-air cell preferably comprises at least one noble metal, in particular platinum and/or palladium and/or manganese oxide, wherein manganese oxide is particularly preferred, as the electrocatalytically active material.

Preferably, the layer-shaped air cathode of the metal-air cell is formed by a porous matrix of a plastic (plastic binder), in particular PTFE, and particles of the electrocatalytically active material. In addition, carbon black, for example, may be included as a conductive agent. During production, these substances can be provided as a dry mixture and formed into a layer by a rolling process. Preferably, the air cathode further comprises a metallic mesh, for example, silver, nickel or silver-plated nickel. Alternatively, metallic meshes, expanded metals, metallized nonwovens, or similar electrical conductors may be used so that a metallic conductor structure is formed. In the manufacturing process, the dry mixture containing the plastic binder and catalyst particles, and optionally carbon black or the like, can be rolled out onto this structure. Circles or similar shapes can then be punched out of this sheet-like structure, which can be used as air cathodes in the housing of a metal-air cell to be manufactured.

The air cathode can be in the form of a cathode disk with a circumferential cathode disk edge. This cathode disk can be arranged in the housing of the metal-air cell such that the edge of the cathode disk abuts the inside of a region of the housing along a circumferential contact zone. In this connection, it is expediently provided that the metallic arrester structure of the air cathode, i.e., for example, the silver mesh or the like, protrudes from the cathode disk at the cathode disk edge. At these points, an electrically conductive connection to the housing of the metal-air cell can be realized, wherein the resulting connection of the air cathode determines the polarity of the housing.

The metal-based anode of the metal-air cell can also be designed in a comparable way to conventional metal-air cells. Preferably, the metal-based anode comprises a metallic powder as the electrocatalytically active material, in particular a powder of metallic zinc and/or aluminum and/or magnesium. Zinc or a zinc alloy is particularly preferred so that in particularly preferred examples of the metal-air cell it is a zinc-air cell. In principle, however, other oxidizable metals such as aluminum and/or magnesium can also be used instead of zinc.

When manufacturing the metal-air cell, the material for the metal-based anode can be introduced into the housing, for example, in the form of a paste.

With respect to the housing, the metal-air cell is preferably characterized by at least one of a. to e.:
a. the first housing part, hereinafter referred to as the cell cup, is cup-shaped and has a cup bottom;
b. the second housing part, hereinafter referred to as the cell lid, is cup-shaped;
c. the first housing part and/or the second housing part consist of a metallic material, in particular steel, preferably nickel-plated steel, and/or sheet metal and/or a trimetal, preferably a trimetal with nickel, steel and copper;
d. at least one electrically insulating seal is provided between the first housing part and the second housing part; and
e. the at least one air passage opening has an opening diameter of 10 to 500 μm.

Preferably, the immediately aforementioned a. and b. and c., especially preferably a. and b. and c. and d., are realized in combination with each other. Furthermore, in these examples, feature e. is preferably also realized.

Further preferably, it may be provided that more than one air passage opening is provided in the housing of the metal-air cell. In this example, the air passage openings can be distributed with particular advantage over the surface of the cup bottom of the cell cup to provide a particularly uniformly distributed entry possibility for the atmospheric oxygen. In general, however, it is sufficient if only one air passage opening is provided, especially since the layer-shaped air diffuser permits particularly good and uniform distribution of the air oxygen entering via the cup bottom.

Particularly preferably, in examples of the metal-air cell, the cell is a button cell, i.e., a cylindrical cell with a round or oval base and a height that is smaller than the diameter of the base. Nevertheless, it is also possible for the metal-air cell to have a different shape.

In particular, the housing of the metal-air cell can comprise the cell cup and cell lid, and expediently a seal. The cell cup and the cell lid form the poles of the cell.

In addition to the bottom region, the cell cup preferably has an annular shell and preferably also a circumferential edge separating the bottom region and the annular shell. The edge can be sharp or rounded.

The cell lid preferably has a similar structure. It generally also has a bottom region and an annular shell. However, instead of a circumferential edge, it can also have a preferably shoulder-shaped transition area.

The cell cup and each of its regions has an interior side facing into the interior space of the cell housing and an oppositely facing exterior side. The same applies to the cell lid and each of its regions.

Preferably, both the cell cup and the cell lid have a circumferential cut edge that forms the opening edge of the cell cup as well as of the cell lid. In preferred examples, the cut edge of the cell lid can have a terminal fold-over, resulting in a double-walled opening edge. The opening edge delimits the respective shell region and defines an opening through which the interior of the cell cup and cell lid can be accessed.

Preferably, the bottom regions of the cell cup and cell lid are flat and have a circular or oval geometry. The same preferably also applies to the opening defined by the opening edge.

Particularly preferably, the flat bottom regions of the cell cup and cell lid are arranged parallel to each other in the housing.

The annular shell regions of the cell cup and cell lid preferably have a circular or oval geometry. Generally, the annular shell regions or at least an axial segment of the annular shell regions are oriented orthogonally or at least substantially orthogonally to the associated bottom regions. The heights of the shell regions are preferably constant each in the circumferential direction.

In the cell cup, it is preferred that the shell region meets the bottom region at an angle of 90°. In this example, the edge of the cell cup preferably forms a sharp boundary between the bottom and shell regions of the cell cup. This is different for the cell lid: although in preferred examples the bottom region of the cell lid also makes an angle of 90° with the annular shell region of the cell lid or at least one axial segment of the shell region, it is preferred that the regions do not directly abut. The resulting gap is filled by the preferably shoulder-shaped transition region.

The cell lid is generally inserted into the cell cup with the cut edge or opening edge first. The seal separates the cell cup and the cell lid from each other. It ensures that the two housing parts are electrically insulated from each other. It also seals the housing from the outside and prevents electrolyte leakage in the boundary area between the cell cup and cell lid.

The housing composed of the cell cup and the cell lid preferably has a basic cylindrical geometry. Generally, the bottom region of the cell cup forms a flat bottom side of the housing while the bottom region of the cell lid forms a flat top side of the housing. Laterally, the housing is bounded by the shell region of the cell cup.

Preferably, the housing is closed by crimping. For this purpose, a terminal segment of the shell region of the cell cup including the opening edge bounding the shell region is pressed radially inwards, resulting in a reduction of the cross-section of the opening defined by the opening edge. Preferably, the crimped opening edge rests on the transition region of the cell lid or on a seal applied in this region. The cell cup and the cell lid are generally interlockingly connected by the crimping.

As mentioned, both the cell cup and the cell lid are preferably made of metallic materials, for example, deep drawing processes. Suitable materials include, for example, nickel-plated deep-drawn sheet or clad composite material with one layer of nickel, one layer of copper and an intermediate layer of steel or stainless steel (so-called trimetal).

The seal is preferably a film seal, as described, for example, in DE 19647593 A1. Film seals made of a thermoplastic are preferred. Suitable materials include polyamide or polyetheretherketone. Alternatively, however, the seal can also be a conventional injection molded seal, for example, also made of a polyamide.

Preferably, the bottom region of the cell cup is substantially flat. It may also be provided that the bottom of the cup has a small step, for example, 0.02-0.09 mm. In the bottom region, which is provided with the air passage opening(s), the layer-shaped air diffusor with the hydrophobic coating is positioned inside the cell. The air diffuser is followed by the air cathode, which may optionally be formed as a laminate with a PTFE membrane or other hydrophobic membrane, wherein the membrane side of the air cathode, if present, faces the air diffuser. If necessary, another hydrophobic layer, in particular another PTFE membrane, can be provided between the air cathode laminate and the layer-shaped air diffuser. This is followed by a layer-shaped separator, which may be in the form of a separator disk, which rests on the air cathode. The separator disk, like the air cathode, which may be designed as a cathode disk, is generally aligned parallel to the bottom region of the cell cup. Above the separator is the metal based anode, for example, in the form of a paste. Towards the top, the housing is closed by the cell lid, which is adjacent to the anode.

The air cathode and the separator, in particular in disc-shaped designs, can first be cut out or punched out of, for example, ribbon-shaped foils during manufacture and then sequentially inserted and/or pressed into the cell cup, preferably onto the bottom region of the cell cup, wherein the layer-shaped air diffusor was previously inserted onto the bottom region. Generally, the air cathode, the separator and the air diffuser, which all may be disc-shaped, are configured as circular disks with approximately the same diameter. They then lie flat on top of each other in the interior space of the housing of the metal-air cell.

Typical examples of the metal-air cells in the form of a button cell are characterized by an approximately cylindrical design with a cell height of about 3.30 mm (PR70 design according to the International Electrotechnical Commission, IEC 60082-2) to 5.40 mm (PR44 design according to IEC) and a cell diameter of about 5.65 mm (PR70 design according to IEC) and 11.60 mm (PR44 design according to IEC).

I further provide a method of manufacturing a layer-shaped air diffusor provided for a metal-air cell according to the above description. The method of manufacturing the layer-shaped air diffusor is characterized by a. to c.:
a. an air-permeable matrix is provided; and
b. the air-permeable matrix is provided with a hydrophobic coating; wherein
c. a dispersion of polytetrafluoroethylene, in particular a dispersion of polytetrafluoroethylene in an aqueous dispersant, for example, in water, or a solution or dispersion of at least one alkyl ketene dimer is used for the hydrophobic coating.

With regard to further details on this method and in particular with regard to the features of the air-permeable matrix and the hydrophobic coating and the associated advantages over conventional air diffusers, reference is also made to the above description.

Particularly preferably, the method is characterized by any of a. or b.:
a. the dispersion of polytetrafluoroethylene has a solid content of polytetrafluoroethylene in the dispersant of 5 to 75% by weight, preferably 15 to 60% by weight, more preferably 30±2% by weight; and
b. the dispersion of the at least one alkyl ketene dimer has a solids content of alkyl ketene dimer in the dispersant of 0.1 to 8.0% by weight, preferably from 0.5 to 3.0% by weight, more preferably 0.5 to 1.0% by weight.

Particularly preferably, the coating is realized by immersion. On the one hand, an immersion process has the advantage that the coating can be carried out very simply, reliably and with little effort using this method. On the other hand, very consistent and reproducible results are hereby achieved without the need for considerable apparatus expenditure. During the immersion process, relatively large sections of the air-permeable matrix can be coated on both sides in a single operation. The required shapes for the air diffuser can then be cut out or punched out, for example.

To carry out the immersion process, the air-permeable matrix, for example, a fiber nonwoven, can be immersed into the PTFE dispersion or the alkyl ketene dimer dispersion for a few seconds (e.g., for 1-10 s). This is preferably followed by drying, which can take place at room temperature or ambient conditions, for example.

I further provide for the use of a layer-shaped air diffusor having an air-permeable matrix with a hydrophobic coating for manufacturing a metal-air cell. In particular, the cell to be produced is a metal-air cell according to the above description. Further details on this use or on a method of manufacturing a metal-air cell using the layer-shaped air diffusor can likewise be obtained from the above description.

In particular, the housing parts for the metal-air cell are provided according to this method. The layer-shaped air diffuser, any additional layers, the air cathode, the separator, which may be impregnated with the electrolyte, and the metal-based anode are inserted into the housing parts and the housing is closed and, if necessary, insulated and/or sealed. Suitable manufacturing processes for this are known.

Further features and advantages will be apparent from the following description of preferred working examples in conjunction with the drawings. The individual features may each be realized separately or in combination with each other.

The drawing shows a cross-section through a metal-air button cell 100, wherein this metal-air cell 100 is equipped with a layer-shaped air diffusor 140 with a hydrophobic coating.

The metal-air cell 100 comprises a metallic housing 110, which is composed of a cell cup 111 (first housing part), a cell lid 112 (second housing part) and a seal 113. The cell cup 111 has, for example, a circular bottom region 111a and an annular shell region 111b. Terminally, the shell region 111b is bounded by the cut edge 111c, which forms the opening edge of the cell cup 111.

The cell lid 112 has a bottom region 112a, which is circular in shape, for example, and an annular shell region 112b. The bottom region 112a of the cell lid 112 and the shell region 112b of the cell lid 112 are connected by a circumferential transition region 112d. Terminally, the shell region 112b is bounded by the cut edge 112c which forms the opening edge of the cell lid 112.

The cell lid 112 is inserted into the cell cup 111 with the cut edge 112c first. A seal 113 separates the cell cup 111 and the cell lid 112 from each other. It ensures electrical insulation of the two housing parts (cell cup 111 and cell lid 112) from each other. It also seals the housing 110 and prevents leakage of the electrolyte.

The cell cup 111 and the cell lid 112 are connected to each other by crimping to form a closed housing 110, wherein the crimping is formed in the region of a terminal segment 111d of the shell region 111b of the cell cup 111 by pressing the terminal segment 111d radially inwards after insertion of the cell lid 112.

An air passage opening 114 is provided in the bottom region 111a of the cell cup 111 at a central position of the bottom region. Air oxygen can enter the interior space of the metal-air cell through the air passage opening 114. Above the air passage opening 114 is the layer-shaped air diffusor 140, which is hydrophobically coated on at least one side. The layer-shaped air cathode 130 adjoins the air diffuser 140, wherein one or two additional layers, in particular PTFE membranes 131 and 132, may be provided between the air diffuser 140 and the air cathode 130. The PTFE membrane 131 closest to the air cathode 130 can form a laminate together with the air cathode 130. A layer-shaped separator 150 is arranged above the air cathode 130, which separates the air cathode 130 from the metal-based anode 120 positioned above the separator 150.

The metal based anode is preferably a zinc paste. The anode 120 is in direct contact with the cell lid 112. Accordingly, the cell lid 112 forms the negative pole of the metal-air cell 100. The separator 150 is impregnated with an alkaline electrolyte, for example, so that hydroxide ions can migrate from the air cathode 130 to the anode 120. The air cathode 130 is provided with a metallic conductor structure, not shown in detail here, which is electrically connected to the cell cup 111. Accordingly, the cell cup 111 forms the positive terminal of the metal-air cell 100.

An important concept lies with the hydrophobic coating of the layer-shaped air diffuser 140. In this context, the air diffuser 140 preferably consists of an air-permeable matrix, which in particular consists of a hydrophilic material. Particularly preferred in this regard is a nonwoven fabric formed from a fiber mixture, wherein the fiber mixture predominantly comprises fibers of polyvinyl alcohol, in particular with a proportion of polyvinyl alcohol fibers of 50% by weight or more. This air-permeable matrix is preferably coated with a dispersion of polytetrafluoroethylene (PTFE) or, more preferably, of at least one alkyl ketene dimer (AKD) in water. The solids content in a polytetrafluoroethylene dispersion is preferably 5 to 75 wt %, particularly preferred is about 30 wt %. The solids content in an alkyl ketene dimer dispersion is preferably 0.01 to 8 wt %, more preferably 0.01 to 3 wt %, more preferably 0.01 to 1 wt %, more preferably 0.01 to 0.8 wt %, most preferably 0.05 to 0.8 wt %. The hydrophobic coating of the air-permeable matrix ensures reliable retention of the electrolyte inside the metal-air cell even in humid environments, wherein at the same time a good distribution of the atmospheric oxygen entering via the air passage opening 114 is ensured over the entire surface of the metal-air cell 100.

A nonwoven fabric with the following properties was used as the air-permeable matrix (nonwoven fabric type PA 125 S from Schweitzer-Mauduit International Inc., USA):

| Weight | 24.8 | g/m² |
|---|---|---|
| Thickness (at 100 kPa) | 88 | μm |
| tensile strength | 2,100 cN/15 mm | |
| Wicking Effect KOH | 50 mm/10 mn | |
| Absorption | 145 | g/m² |
| Shrinkage | 0% | MD |
| | 0% | CD |

| | |
|---|---|
| Air permeability | 29.360 cm/cm³² *min (1 kPa) |
| R. Index | 0.75 |

These measured values of the fiber fleece refer to measurements at a temperature of 23° C. and a humidity of 50%.

### PTFE Coating

The nonwoven was coated with PTFE dispersions of different concentrations in an immersion process, and the weight per unit area and air permeability according to Gurley were measured in comparison with a noncoated nonwoven and a PTFE membrane. A water-based starting dispersion with 60% PTFE solids content was used to prepare the dispersions with different PTFE concentrations. This initial dispersion was mixed with water. In this way, mixtures with about 6 wt % PTFE (10% PTFE starting dispersion+90% water), with about 15 wt % PTFE (25% PTFE starting dispersion+75% water), with about 30 wt % PTFE (50% PTFE starting dispersion+50% water) and with about 60 wt % PTFE (100% PTFE starting dispersion) were provided. These blends were used for coating the fiber web in an immersion process. For the immersion process, the fiber web was immersed in the respective PTFE dispersion for 1-10 s and then dried at room temperature.

The Gurley method of measuring air permeability records the time taken for the respective medium, i.e., air, to flow through the test material under defined conditions. The longer the time, the less permeable the test material. However, if the test material is highly permeable, no time can be measured because the test material has flowed through too quickly (not measurable).

Table 1 summarizes the results.

TABLE 1
Physical properties of the PTFE-coated nonwoven fabric

| | | weight per | |
|---|---|---|---|
| | Air permeability (Gurley) | unit area | |
| Fiber fleece without coating | not measurable (highly permeable) | 25 | g/m² |
| Fiber fleece with approx. 6 wt. % PTFE | not measurable (highly permeable) | 45 | g/m² |
| Fiber fleece with approx. 15 wt. % PTFE | not measurable (highly permeable) | 48 | g/m² |
| Fiber fleece with approx. 30 wt. % PTFE | not measurable (highly permeable) | 67 | g/m² |
| Fiber fleece with approx. 60 wt. % PTFE | 24 s | 144 | g/m² |
| PTFE diaphragm | 75 s | 175 | g/m² |

The results show that the nonwoven fibers coated with a PTFE dispersion exhibit very high air permeability up to a weight per unit area of 67 g/m². When the fiber fleece is coated with a non-diluted PTFE dispersion (60 wt. % PTFE, weight per unit area 144 g/m²), a weakening influence on the air permeability is shown, which is already significantly reduced compared to a coating with a 30 wt. % PTFE dispersion. In contrast, a pure PTFE membrane shows even significantly poorer air permeability.

Table 2 shows the results of experiments with various metal-air cells, each with differently coated air diffusers. For each type of air diffuser, three individual cells (cells #1, #2, #3) were observed over several days under high humidity conditions (90% relative humidity at 30° C.) to determine if electrolyte leakage was detected after discharge (x—electrolyte leakage; ∘—no electrolyte leakage).

TABLE 2
Electrolyte leakage after discharge under high-humidity conditions

| | Cell No. | Day 1 | Day 2 | Day 3 | Day 4 | Day 5 | Day 6 | Day 7 |
|---|---|---|---|---|---|---|---|---|
| Non-coated fiber fleece | 1 | x | — | — | — | — | — | — |
| | 2 | x | — | — | — | — | — | — |
| | 3 | ∘ | ∘ | ∘ | ∘ | ∘ | ∘ | ∘ |
| Fiber nonwoven with a coating | 1 | x | — | — | — | — | — | — |
| containing approx. 6 wt. % PTFE | 2 | ∘ | ∘ | ∘ | x | — | — | — |
| | 3 | ∘ | ∘ | ∘ | ∘ | ∘ | ∘ | ∘ |
| Fiber nonwoven with a coating | 1 | ∘ | ∘ | ∘ | x | — | — | — |
| containing approx. 15 wt. % PTFE | 2 | ∘ | ∘ | ∘ | x | — | — | — |
| | 3 | ∘ | ∘ | ∘ | ∘ | ∘ | ∘ | ∘ |
| Fiber nonwoven with a coating | 1 | ∘ | ∘ | ∘ | ∘ | ∘ | ∘ | ∘ |
| containing approx. 30 wt. % PTFE | 2 | ∘ | ∘ | ∘ | ∘ | ∘ | ∘ | ∘ |
| | 3 | ∘ | ∘ | ∘ | ∘ | ∘ | ∘ | ∘ |

The results show that with an air diffuser coated with a 30 wt. % PTFE dispersion, electrolyte leakage was reliably prevented over a period of seven days in all the individual cells of this type examined. An air diffuser with a 15 wt. % PTFE dispersion coating already showed a positive effect in terms of protection against electrolyte leakage, whereby this positive effect was also observed to some extent when the air diffuser was coated with a 6 wt. % PTFE dispersion. For particularly reliable protection against leakage of the metal-air cells, a PTFE dispersion of approx. 30 wt. % is therefore particularly preferred for coating the air diffuser.

### AKD Coating

In a comparable manner, fiber nonwovens (fiber nonwoven type PA 125-35 S and type PA 125 from Schweitzer-Mauduit International Inc., USA) were coated with alky-ketene dimers (AKD). Type PA 125-35 S, in contrast to type PA 125, is provided with a wetting agent. Aqueous dispersions with 0.8 wt % and with 7.6 wt % AKD were used for the coating. The AKD material used was AQUAPEL® 201 (Solenis LLC, USA).

A water drop method was used to measure the hydrophobicity. A drop of water (2 μl) is placed on the fiber fleece. Then the time is stopped until the fiber fleece has absorbed the water. Thus, the longer the measured time period, the greater the hydrophobicity. If the water droplet has not yet been absorbed after 15 min, the test was stopped (result >15 min/2 μl).

Table 3 summarizes the material properties of the fiber webs coated with AKD.

TABLE 3
Physical properties of the fiber webs coated with AKD

| | Weight per | | |
|---|---|---|---|
| | unit area | Air permeability (Gurley) | Hydrophobicity |
| Fiber fleece (PA 125-35 S) | 24 g/m² | not measurable (highly permeable) | 2 s/2 μl |
| without coating | | | |
| PA 125-35 S with 0.8% AKD | 24 g/m² | not measurable (highly permeable) | >15 min/2 μl |
| PA 125-35 S with 7.6% AKD | 28 g/m² | not measurable (highly permeable) | >15 min/2 μl |
| Fiber fleece (PA 125) | 25 g/m² | not measurable (highly permeable) | 5 s/2 μl |
| without coating | | | |
| PA 125 with 0.8% AKD | 24 g/m² | not measurable (highly permeable) | >15 min/2 μl |
| PA 125 S with 7.6% AKD | 28 g/m² | not measurable (highly permeable) | >15 min/2 μl |

For both fiber webs which were investigated (PA 125-35 S and PA 125), coating with both 0.8% AKD and 7.6% AKD resulted in very good hydrophobicity values (>15 min/2 μl). The measurable thickness of the nonwovens was not significantly affected by the coatings and was 80 to 100 μm in all examples. The weight per unit area of the nonwovens was unchanged when coated with 0.8% AKD. A slight elevation of the weight per unit area was observed for the coating with 7.6% AKD. The air permeability was very good in all examples and was not measurably affected by the AKD coating.

In further trials, lower AKD concentrations were also tested. Already at a concentration of 0.08% AKD, a clearly elevated hydrophobicity was found compared to the uncoated fiber fleece. A further significant elevation in hydrophobicity was observed at 0.16% AKD and at 0.8% AKD (in practice 0.76% AKD). Above 0.8% AKD, no further significant improvement with respect to hydrophobicity was observed.

Table 4 shows the results of tests with various metal-air cells, each with air diffusers coated with different amounts of AKD (uncoated nonwoven (PA 125-35 S); nonwoven coated with 0.8% AKD (PA 125-35 S); nonwoven coated with 7.6% AKD (PA 125-35 S)). Percentages are based on weight percent of coating dispersion. For each type of air diffuser, four individual cells (cells No. 1, 2, 3, 4) were observed for a total of 7 days under high-humidity conditions to determine whether electrolyte leakage was detected immediately after discharge or after 1 day or after 3 days or after 7 days of deep discharge (x-electrolyte leakage; 0-no electrolyte leakage).

TABLE 4
Electrolyte leakage after discharge under high-humidity conditions

| | Cell | Protrude from | Protrude from | Protrude from | Protrude from |
|---|---|---|---|---|---|
| | No. | after discharge | after 1 day | after 3 days | after 7 days |
| Non-coated fiber fleece | 1 | 0 | x | — | — |
| (PA 125-35 S) | 2 | 0 | 0 | x | — |
| | 3 | 0 | 0 | x | — |
| | 4 | 0 | x | — | — |
| Nonwoven coated with 0.8 | 1 | 0 | x | — | — |
| % AKD (PA 125-35 S) | 2 | 0 | 0 | 0 | x |
| | 3 | 0 | 0 | 0 | 0 |
| | 4 | 0 | 0 | 0 | 0 |
| Nonwoven coated with 76 | 1 | 0 | 0 | 0 | 0 |
| % AKD (PA 125-35 S) | 2 | 0 | 0 | x | — |
| | 3 | 0 | 0 | x | — |
| | 4 | 0 | 0 | 0 | 0 |

The results show that electrolyte leakage after deep discharge occurs more frequently and more quickly with the uncoated fiber fleece as air diffuser than with the fiber fleece coated with AKD. With regard to electrolyte leakage, the results with a 0.8% AKD coating were comparable to the results with a 7.6% AKD coating. Due to the lower material consumption for the 0.8% AKD coating and the easier handling of the lower concentration dispersion, this coating is particularly advantageous for the air diffuser.

1-15. (canceled)

16. A metal-air cell comprising:
a. a first housing part and a second housing part that together form a cell housing; and
b. a metal based anode, a layer-shaped air cathode and an electrolyte, wherein
c. the first housing part has at least one air passage opening,
d. a layer-shaped air diffusor is arranged between the first housing part and the air cathode,
e. a layer-shaped separator is arranged between the air cathode and the metal-based anode,
f. the layer-shaped air diffusor is configured to be air permeable and has a first side facing the air cathode and a second side facing away from the air cathode, and
g. the layer-shaped air diffusor has a hydrophobic coating on at least one of the sides.

17. The metal-air cell of claim 16, wherein the hydrophobic coating is a polytetrafluoroethylene coating.

18. The metal-air cell of claim 16, wherein the hydrophobic coating is an alkyl ketene dimer coating.

19. The metal-air cell of claim 17, wherein at least one of
a. the hydrophobic coating is based on a coating with a dispersion of polytetrafluoroethylene or a water-based dispersion;
b. the hydrophobic coating is based on a coating with a dispersion of polytetrafluoroethylene in an aqueous dispersant, wherein a solid content of polytetrafluoroethylene in the dispersion is 5 to 75% by weight;
c. the hydrophobic coating is based on a coating with a solution or dispersion of at least one alkyl ketene dimer; and
d. the hydrophobic coating is based on a coating with a dispersion of at least one alkyl ketene dimer in an aqueous dispersant, wherein a solid content of the at least one alkyl ketene dimer in the dispersion is 0.01 to 8.0% by weight.

20. The metal-air cell according to claim 16, wherein the layer-shaped air diffuser comprises an air-permeable matrix formed of a hydrophilic material.

21. The metal-air cell of claim 20, wherein at least one of
a. the air-permeable matrix is a nonwoven fabric,
b. the air-permeable matrix is formed of a fiber mixture, wherein the fiber mixture comprises fibers of polyvinyl alcohol in a proportion of at least 50% by weight,
c. the air-permeable matrix has a weight per unit area in the uncoated state of 20 to 30 g/m², and
d. the air-permeable matrix has, in a uncoated state, an air permeability of 20,000 to 40,000 cm³/cm²*min.

22. The metal-air cell according to claim 16, wherein the layer-shaped air diffusor has a coating on both sides.

23. The metal-air cell of claim 16, wherein any one of
a. the layer-shaped air diffusor has a coating of polytetrafluoroethylene and a weight per unit area of 40 to 160 g/m², and
b. the layer-shaped air diffusor has a coating with at least one alkyl ketene dimer and a weight per unit area of 10 to 50 g/m².

24. The metal-air cell of claim 16, wherein at least one of
a. the metal-air cell further comprises at least one additional layer between the air cathode and the layer-shaped air diffusor, and
b. the at least one additional layer is a hydrophobic membrane or a membrane made of polytetrafluoroethylene.

25. The metal-air cell of claim 16, wherein
a. the metal-air cell is a zinc-air cell, or
b. a button cell.

26. A method of manufacturing a layer-shaped air diffusor for the metal-air cell according to claim 16, comprising:
providing an air-permeable matrix; and
the air-permeable matrix with a hydrophobic coating, wherein
a dispersion of polytetrafluoroethylene in an aqueous dispersant, or a solution or dispersion of at least one alkyl ketene dimer is used for the hydrophobic coating.

27. The method of claim 26, wherein any of
a. the dispersion of polytetrafluoroethylene has a solid content of polytetrafluoroethylene in the dispersant of 5 to 75% by weight, and
b. the dispersion of the at least one alkyl ketene dimer has a solids content of alkyl ketene dimer in the dispersant of 0.01 to 8.0% by weight.

28. The method of claim 26, wherein the coating is provided by an immersion process.
